(19) United States
(12) Patent Application Publication
(10) Pub. No.: US 2024/0139971 A1
(43) Pub. Date: May 2, 2024

(54) PNEUMATIC SYSTEMS AND METHODS FOR PROVIDING HIGH FLOW VACUUM ACQUISITION IN AUTOMATED SYSTEMS

(71) Applicant: Berkshire Grey Operating Company, Inc., Bedford, MA (US)

(72) Inventors: Matthew T. MASON, Pittsburgh, PA (US); William Chu-Hyon MCMAHAN, Cambridge, MA (US); Benjamin CHOEN, Somerville, MA (US); Bretton ANDERSON, Westford, MA (US); John Richard AMEND, JR., Belmont, MA (US); Joseph ROMANO, Arlington, MA (US); Christopher GEYER, Arlington, MA (US)

(21) Appl. No.: 18/384,235

(22) Filed: Oct. 26, 2023

Related U.S. Application Data
(60) Provisional application No. 63/419,582, filed on Oct. 26, 2022.

(51) Int. Cl. B25J 15/06

(52) U.S. Cl. CPC B25J 15/0625

(57) ABSTRACT

A system is disclosed for providing high flow vacuum control to an end-effector of a programmable motion device. The system includes a vacuum source for providing a high flow vacuum, a conduit path leading from the end-effector to the high flow vacuum source, a sensor system for sensing any of a pressure or a flow at any of the end-effector, the conduit path, and the vacuum source, and providing sensor information, and a pneumatic control module including a vacuum pressure adjustment system for adjusting the high flow vacuum within the conduit path responsive to the sensor information.

### PRIORITY

The present application claims priority to U.S. Provisional Patent Application No. 63/419,582 filed Oct. 26, 2022, the disclosure of which is hereby incorporated by reference in its entirety.

### BACKGROUND

The invention generally relates to robotic and other sortation systems and relates in particular to programmable motion systems having an articulated arm with an end effector that employs vacuum pressure to engage objects in the environment.

Most vacuum grippers employ vacuum pressures well below 50% of atmospheric pressure, and are referred to herein as high vacuum. A typical source for a high vacuum gripper is a Venturi ejector, which produces high vacuum but low maximum air flow. Because of the low flow, it is essential to get a good seal between a vacuum gripper and an object, and it is also important to minimize the volume to be evacuated.

The principle of the Venturi pump for generating vacuum is that compressed air blown over an aperture generates negative differential pressure at the aperture. The compressed air is typically generated by a large compressor that will feed multiple pneumatic systems. Switching of the vacuum is thus performed through a valve which switches on or off the supply of compressed air to the Venturi pump. Thus, Venturi-based systems for vacuum gripping have two states: on or off.

Suppliers of ejectors and related system components include Vaccon Company, Inc. of Medway, MA, Festo US Corporation of Hauppauge, NY, Schmalz, Inc. of Raleigh, NC and others. In some instances where a good seal is not possible, some systems use high flow devices. Typical high flow devices are air amplifiers and blowers, which produce the desired flows, but cannot produce the high vacuum of a high vacuum source. High flow sources include the side-channel blowers supplied by Elmo Rietschle of Gardner, Denver, Inc. of Quincy, IL, Fuji Electric Corporation of America of Edison, NJ, and Schmalz, Inc. of Raleigh, NC. It is also possible to use air amplifiers as supplied by EDCO USA of Fenton, MO and EXAIR Corporation of Cincinnati, OH. Multistage ejectors are also known to be used to evacuate a large volume more quickly, wherein each stage provides higher levels of flow but lower levels of vacuum.

Despite the variety of vacuum systems, however, there remains a need for an end effector in a robotic or other sortation system that is able to accommodate a wide variety of applications, involving engaging a variety of types of items. There is further a need for an end effector that is able to provide high flow and that is able to handle a wide variety of objects weights.

### SUMMARY

In accordance with an aspect, the invention provides a system for providing high flow vacuum control to an end-effector of a programmable motion device. The system includes a vacuum source for providing a high flow vacuum, a conduit path leading from the end-effector to the high flow vacuum source, a sensor system for sensing any of a pressure or a flow at any of the end-effector, the conduit path, and the vacuum source, and providing sensor information, and a pneumatic control module including a vacuum pressure adjustment system for adjusting the high flow vacuum within the conduit path responsive to the sensor information.

In accordance with another aspect, the invention provides a system for providing high flow vacuum control to an end-effector of a programmable motion device. The system includes a high flow vacuum source including a rotating element that provides a high flow vacuum at the end-effector when the rotating element is rotating at a first rotational speed, and a pneumatic control system for a first period of time between discharge of a first object being grasped and an initial grasp of a second object to be grasped subsequent to the first object, and a second period of time that is less than the first period of time during which power to the rotating element is decreased and subsequently increased such that the rotating element returns to the first rotational speed prior to grasping the second object.

In accordance with a further aspect, the invention provides a method of providing high flow vacuum control to an end-effector of a programmable motion device. The method includes providing, using at least in part a rotating element, a high flow vacuum at the end-effector when the rotating element is rotating at a first rotational speed, identifying a first period of time between discharge of a first object being grasped and an initial grasp of a second object to be grasped subsequent to the first object, decreasing power to the rotating element for a second period of time that is less than the first period of time, and increasing rotational speed of the rotating element prior to grasping the second object.

### BRIEF DESCRIPTION OF THE DRAWINGS

The following description may be further understood with reference the accompanying drawings in which:

FIG. 1 shows an illustrative diagrammatic view of an object processing system that includes a pneumatic control module in accordance with an aspect of the present invention;

FIGS. 2A and 2B show illustrative diagrammatic views of the end-effector of the system of FIG. 1 with the arm attachment section of the end-effector withdrawn relative the shaft portion (FIG. 2A) and extended relative the shaft portion (FIG. 2B);

FIG. 3 shows an illustrative diagrammatic schematic view of the hardware of the system of FIG. 1;

FIG. 4 shows an illustrative diagrammatic view of a pneumatic control module for use in an object processing system in accordance with another aspect of the present invention;

FIGS. 5A-5B show illustrative diagrammatic views of an operating mode of the pneumatic control system in accordance with an aspect of the present invention, showing a cup pressure flow curve (FIG. 5A) for a robot gripping an object with the valve closed and the cup sealed (FIG. 5B);

FIG. 6 shows an illustrative diagrammatic view of a further operating mode of the pneumatic control system FIG. 5B, showing the robot not gripping the object with the valve open;

FIGS. 7A-7B show illustrative diagrammatic views of a further operating mode of the pneumatic control system FIG. 5B, showing a cup pressure flow curve (FIG. 7A) for a pressure drop due to friction through the object where a grip is maintained (FIG. 7B);

FIGS. 8A-8B show illustrative diagrammatic views of a further operating mode of the pneumatic control system FIG. 5B, showing a cup pressure flow curve (FIG. 8A) for a closed valve with an unsealed cup (FIG. 8A);

FIGS. 9A-9B show illustrative diagrammatic views of a further operating mode of the pneumatic control system FIG. 5B, showing a cup pressure flow curve (FIG. 9A) for a partially opened valve (FIG. 9B);

FIGS. 10A-10B show illustrative diagrammatic views of a further operating mode of the pneumatic control system FIG. 5B, showing a cup pressure flow curve (FIG. 10A) for a change of AC frequency to the blower motor (FIG. 10B);

FIG. 11 shows an illustrative diagrammatic view of a further operating mode of the pneumatic control system FIG. 5B, showing a reverse motor direction applied to blow detritus off of the gripper;

FIG. 12 shows an illustrative diagrammatic sectional view of a vacuum cup used in a gripping system in accordance with another aspect of the present invention;

FIG. 13 shows an illustrative diagrammatic force diagram view of tension per unit length of an area exposed to vacuum in the vacuum cup of FIG. 12;

FIG. 14 shows an illustrative diagrammatic sectional view of an end-effector with an internal spring that is coupled to a vacuum source; and

FIG. 15 shows an illustrative diagrammatic sectional view of an end-effector with an internal spring that is decoupled from a vacuum source.

The drawings are shown for illustrative purposes only.

### DETAILED DESCRIPTION

In accordance with an aspect, the invention provides an electromechanical and pneumatic system for performing unit handling tasks for a wide variety of items. In accordance with various aspects, the invention provides an end-effector system for programmable motion devices (e.g., robotic systems) that provides high flow vacuum to grasp objects. The high flow vacuum is provided at a vacuum cup as the end-effector of the end-effector system that is coupled to a high flow vacuum system. The vacuum cup is attached to a cup attachment portion, which is in turn attached to an arm attachment portion that is attached to an articulated arm of the robotic system.

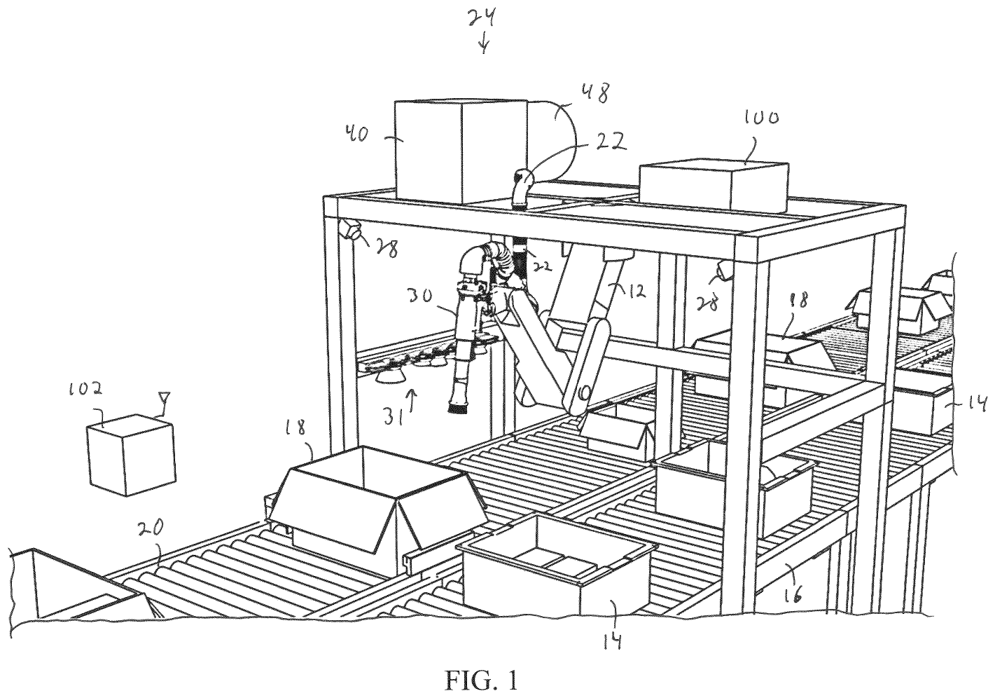

FIG. 1, for example, shows an object processing system 10 that includes a programmable motion device 12 for moving objects from input bins 14 on an input conveyor 16 to output containers 18 (e.g., boxes) on an output conveyor 20. The programmable motion device 12 includes an end-effector system 30 that is coupled to a vacuum source 24 via a vacuum hose 22. The vacuum source 24 includes a pneumatic control module 40 with a blower 48. Operation of the system, including the programmable motion device 12, the end-effector system 30, the perception units 28, and the conveyors 16, 20, is controlled by one or more computer processing systems 102. Operation of the system, including the programmable motion device, controllers, modules, valves and the blower may be controlled by one or more computer processing systems 100. The vacuum source 24, computer processing system(s) 100 and programmable motion device 12 may be mounted on a support structure 26 that also includes the perception units 28 for aiding in the processing of objects and movement of the programmable motion device, including the end-effector system 30.

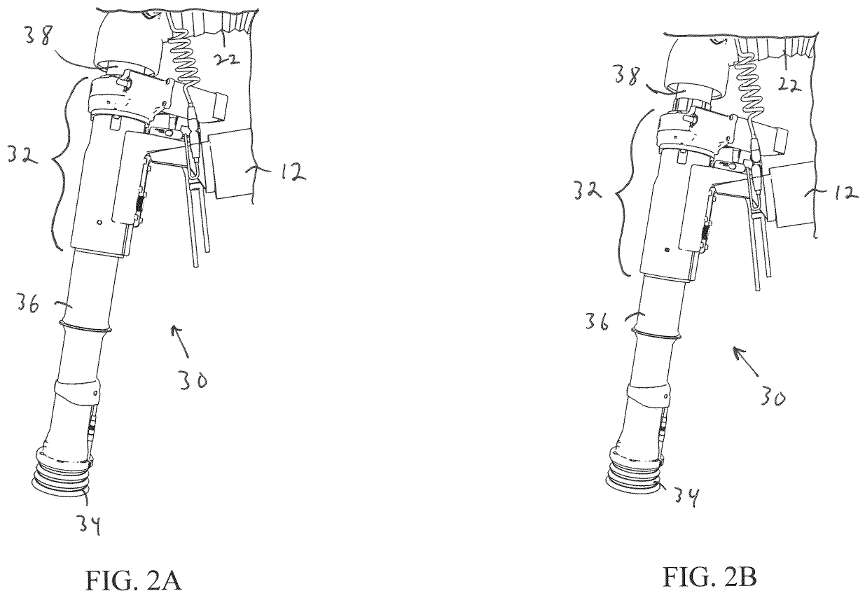

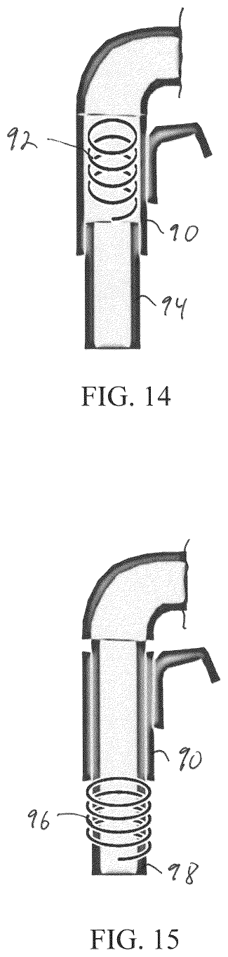

With reference to FIG. 2A, the end-effector system 30 includes an arm attachment section 32 for coupling the end-effector system 30 to the programmable motion device 12. The arm attachment section 32 is coupled to an inner rotational spline shaft portion 36 (providing rotation) via a spring-biased axial displacement mechanism. The rotational spline shaft portion 36 is coupled at a distal end to a vacuum cup 34 and is coupled at a proximal end 38 to the vacuum hose 22. With further reference to FIG. 2B, the spring biased axial displacement mechanism permits the programmable motion device 12 and arm attachment section 32 to move relative the rotational spline shaft portion 36 while grasping objects, which relieves the system from having reactive forces from adversely affecting the programmable motion device 12 or damaging objects being grasped. FIG. 2A shows the arm-attachment section 32 at rest with respect to the shaft portion 36, and FIG. 2B shows the arm-attachment section 32 being having moved relative the shaft portion 36 against the spring-bias. Arrangements for springs within the end-effector to provide such biasing may be as shown in FIG. 14 or 15.

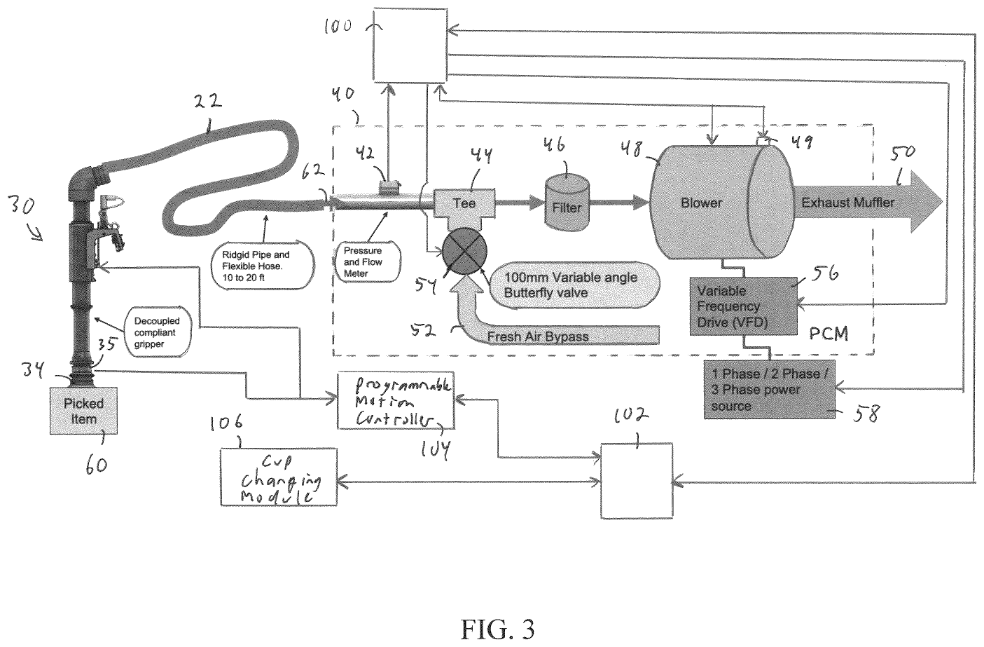

In accordance with various aspects, the invention provides the design of an electromechanical and pneumatic system for performing unit handling tasks with a wide variety of items, as well as the behaviors enabled by such a design. An illustrative diagrammatic schematic view of the hardware system is shown in FIG. 3, which shows the vacuum hose 12 coupled to the end-effector 30 at one end and to a pneumatic control module (PCM) 40 at the other end. The PCM is typically housed in a noise reducing enclosure, with vents to allow air flow in and interior space to allow air flow around the blower to cool it.

The pneumatic control module 40 includes a pressure and flow meter 42 coupled to the vacuum hose 12, which is coupled to a tee-fitting 44. The output of the tee-fitting 44 is passed through a filter 46, then through a blower 48 leading to an exhaust muffler 50. A source of fresh air bypass 52 is provided via an air valve 54 to the tee-fitting 44, and the blower 48 is controlled by a variable frequency drive 56 coupled to a 1-phase/2-phase/3-phase power source 58.

As shown in FIG. 3, a picked object 60 is held by the vacuum cup 34 of the end-effector 30 when the valve 54 is closed and the vacuum blower 48 is turned on. The vacuum cup 34 provides a compliant conduit of vacuum that contacts the object 60 when gripping. The compliant features of the vacuum cup 34 such as bellows and/or a lip facilitate creating a seal between the cup 34 and the object 60. The end-effector 30 on the programmable motion device (e.g., a robotic articulated arm) provides the gripper that holds the suction cup and is also a conduit for vacuum to the cup. The gripper may have mechanical compliance in order to prevent damage to objects and/or the robotic articulated arm. The end-effector may also include sensors such as load sensors to detect deflection (e.g., any deflection or the amount of deflection) of the compliant member, and/or flow sensors, and/or pressure sensors. The pressure and flow sensors may be mounted to a pipe at 62 to which the hose 22 is coupled.

The vacuum hose 22 is a flexible conduit for coupling to the vacuum source that allows the robotic articulated arm 12 to move in the workspace. The hose length and diameter are chosen to minimize pressure loss. The hose length is no longer than required to allow the robot to move freely in the required workspace, e.g., about 10 to 20 feet. The hose diameter balances the time required to evacuate the air in the hose and the pressure losses from choosing a narrower hose, e.g., about 2 inches.

The tee-fitting provides an air manifold for three connections: the pipe going to the gripper; the pipe going to the blower; and the valve. The straightaway section of the tee-fitting 44 connects the gripper and blower pipes, which minimizes the total pressure drop at the gripper at high flow rates. The base of the tee-fitting 44 connects to the valve 54. In this system design, the valve 54 is not in the flow path from the gripper 30 to the blower 48. The valve 54 opens to allow fresh air (via bypass 52) to flow with a minimum impedance to the blower 48.

The valve 54 may be a butterfly valve that when open allows ambient air to enter the tee-fitting 44. When the valve is open, because of the resistance or pressure drop of the hose 22, air will flow through the valve 54 and tee-fitting 44 to the blower 48, and there will be minimal negative pressure at the suction cup. When the valve 54 is closed, the conduit is a closed system from the blower 48 to the suction cup 34 opening and the blower 48 pulls air from the suction cup 34. In addition to butterfly valves, other types of valves may be effective, such as a poppet valve, a ball valve, a gate valve, etc. A butterfly valve is balanced and requires minimal torque to actuate, though care should be taken to ensure that the butterfly plate (or disc) does not deform under the vacuum pressure.

The filter 46 prevents debris or detritus from entering the blower 48. The filter 46 may be a cylindrical axial filter with an inlet and an opposing outlet that is otherwise sealed. Air passing from inlet and outlet goes through a removable air filter. The blower 48 is the high flow vacuum source and may be a regenerative blower, centrifugal blower, or positive displacement blower such as a rotary vane, or claw vacuum pump, or may be some other vacuum source that produces a high flow vacuum. The blower may include a pressure and/or flow sensor 49 that provides sensor output information for the processing system(s). Providing the sensor information from a sensor 49 at the blower provides improved sensor data acquisition speed regarding grasp attempts at the end-effector in certain applications. The blower may be driven by an AC motor, and the AC motor may be controlled by the variable frequency drive (VFD) 56 which serves as the motor controller for the blower's motor using the 1-phase/2-phase/3-phase power source 58. The variable frequency drive 56 varies the frequency going to the motor for the blower 48, allowing the variable frequency drive 56 to set the speed and direction of the blower motor. The VFD 56 has the capacity to control ramp-up and ramp-down of the blower motor during start or stop, respectively. Control of motor speed allows control of the blower's maximum pressure and flow. With some blower technologies, such as a regenerative blower, directional control of the motor allows the air to reverse direction. The exhaust muffler 50 minimizes noise produced by outgoing air from the blower.

As also shown in FIG. 3, the one or more processing systems 100 receives sensor data information from the pressure and/or flow sensor(s) 42 and is in communication with the blower 48 and the analog adjustable valve 54 (e.g., the butterfly valve). The one or more processing systems 100 is also in communication with each of the variable frequency drive 56 and the multi-phase power source 58, as well as the one or more computer processing systems 102. The one or more further computer processing systems 102 provide control signals to the programmable motion device 12 (as discussed above) via a programmable motion controller 104, and provide control signals to and from a cup changing module 106 that provides the ability for the programmable motion device 12 to exchange vacuum cups at a cup exchange station (shown at 31 in FIG. 1). The programmable motion controller 104 is also in communication with a pressure and/or flow sensor 35 at the end-effector (e.g., in the flow path within the end-effector) that provides sensor information to the processing system(s). The system therefore provides pressure and/or flow detection at any of the end-effector, the conduit path, and the vacuum source, and provides sensor information use by the processing system as discussed herein.

In accordance with various aspects therefore, the pneumatic control module may adjust either or both of the analog adjustable valve and/or the power to the blower (e.g., via frequency control) responsive to the sensor output information from the one or more sensors (e.g., 35, 42, 49). In accordance with further aspects, the system may identify an object being grasped (either prior to or during grasping) and the system may obtain object specific grasping information. The system may then adjust either or both of the analog adjustable valve and/or the power to the blower (e.g., via frequency control) responsive to the object specific grasping information. In accordance with further aspects, the system may adjust the valve 54 and/or power to the blower 48 responsive to either or both the sensor information and/or the object specific information and may further coordinate with the cup changing module 106 to provide an optimal choice of vacuum cup for a next object to be grasped. The system may, for example, determine that a different size vacuum cup should be used, instructing the programmable motion device to exchange cups as disclosed for example, in U.S. Patent Application Publication No. 2019/0217471, the disclosure of which is hereby incorporated by reference in its entirety. The system may determine this based on any of sensor data and object specific data, and may combine the cup change with adjusting either or both the valve 54 and/or power to the blower as discussed above. The system therefore provides finely adjustable high flow vacuum for a wide variety of objects including object packaging.

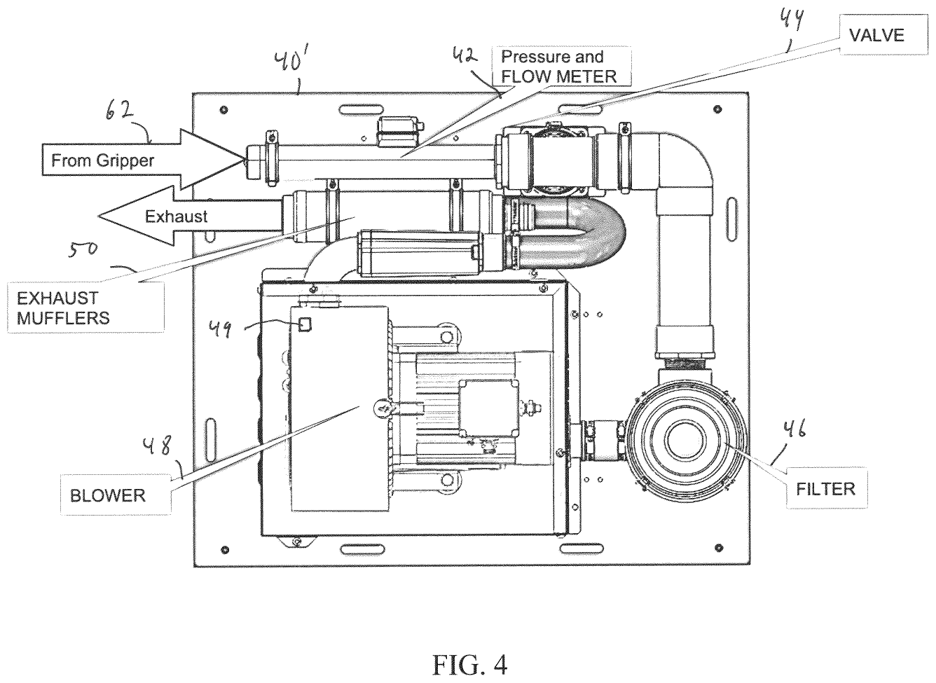

FIG. 4 shows a diagrammatic view of a pneumatic control module 40′ similar to the pneumatic control system 40. The pneumatic control system 40′ includes different arrangement of the hose connection 62 for the vacuum hose, the pressure and flow meters 35, 42, 49, the valve 44, the filter 46, the blower 48 and the exhaust muffler 50, and provides inflow and outflow at the same end thereof.

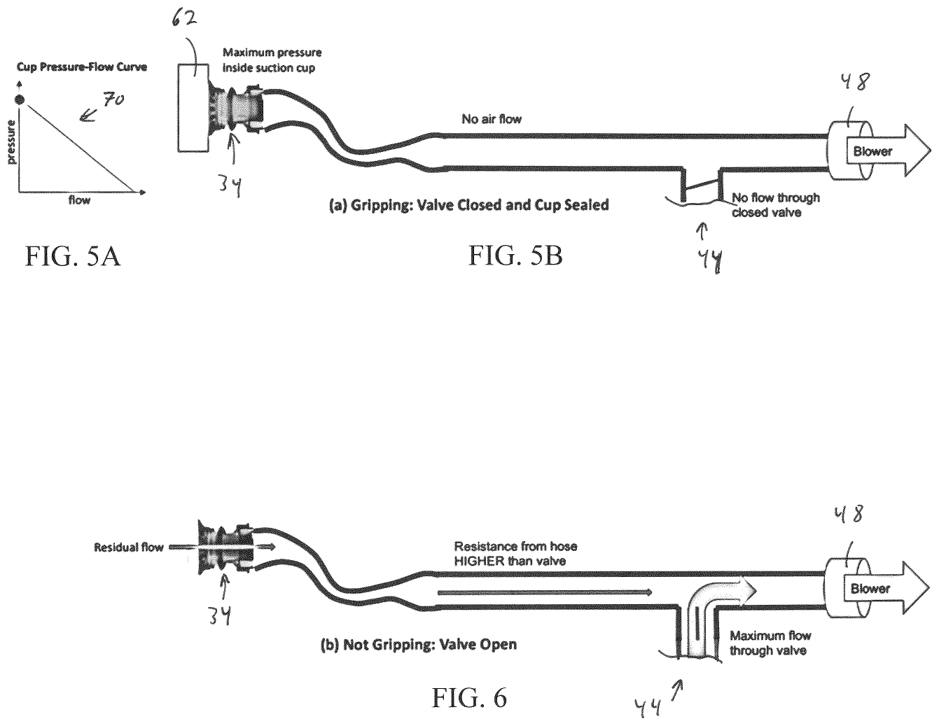

With reference to FIGS. 5A-11, there are many operating modes of the pneumatic system. With reference to FIGS. 5A and 5B, in one operating mode the robot plans to grip an object 62, and the system closes the valve 44. FIG. 5A shows at 70 the associated cup pressure-flow curve showing the direct relationship wherein the pressure is high and the flow is low. The conduit from the blower 48 to the object is sealed against the suction cup 34 (the conduit is closed), and the surface of the object 62 is exposed to the vacuum being generated by the blower 48 as shown in FIG. 5B. The differential pressure at the vacuum cup 34 is at its maximum as shown at 70 showing the pressure-flow curve of the pressure and flow at the vacuum cup 34. When the robot plans to release an object, it opens the valve 44 as shown in FIG. 6. The blower 48 is still operating, but because of resistance in the hose to the gripper, the path of least resistance for air is through the open valve 44. The open valve 44 has some small resistance so there is some residual flow/pressure through the suction cup and hose (the larger the valve the less the residual flow/pressure).

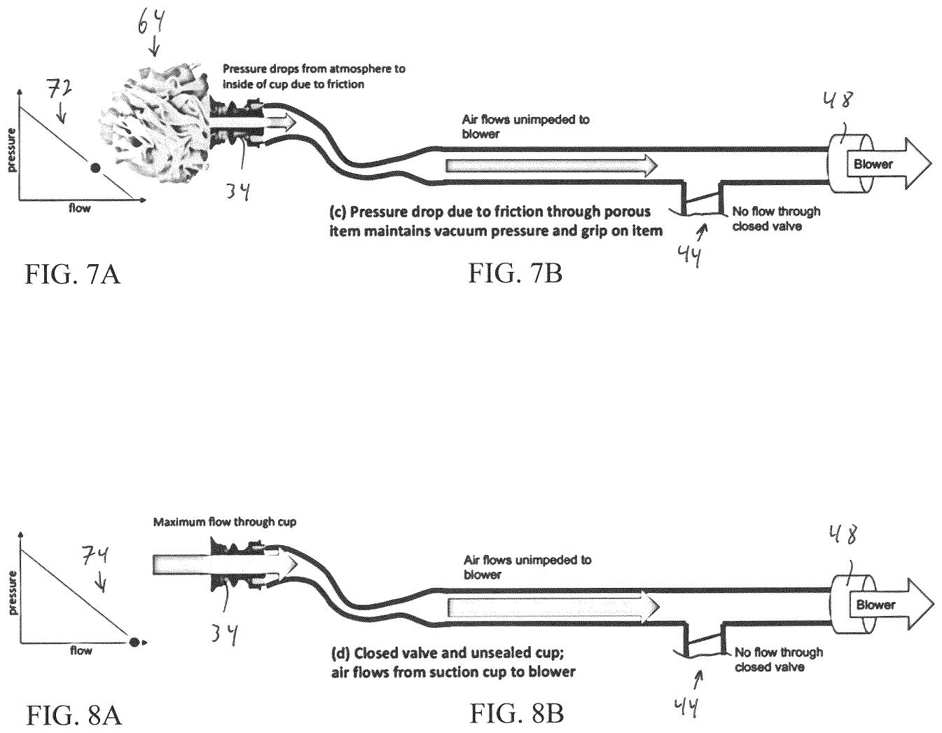

When a porous object is being gripped, or an irregularly shaped object that resists sealing is being gripped, air will flow through or around the object. FIG. 7B shows a porous object 64 being gripped by the vacuum cup 34 and FIG. 7A shows the pressure-flow associated pressure-flow relationship at 72 wherein the pressure is lower but the flow is higher. The air flow faces a friction, which will induce a pressure drop, or difference between atmospheric pressure and the pressure inside the vacuum cup 34 at the surface of the object 64. If that pressure difference is large enough, the robot can securely grasp the object using a reduced but sufficient amount of vacuum as shown at 72. The design of the high flow blower 48 combined with the valve with the tee means that the flow to the blower 48 is not significantly impacted by a pressure loss, which would reduce the pressure at the suction cup 34. The blower 48, for example, may be a side-channel blower with that provides a vacuum with an airflow of at least about 100 cubic feet per minute, and a vacuum pressure at the end effector of no more than about 65,000 Pascals below atmospheric (e.g., about 50,000 Pascals below atmospheric or 7.25 psi). The high flow vacuum may also be provided by an air-amplifier in accordance with further aspects of the invention. The design is therefore able to better provide pressure at the suction cup when gripping porous or irregularly shaped objects compared with designs where the valve would be in-line.

With reference to FIG. 8B, if the robot attempts to grip an object when the valve 44 is closed, but it incorrectly positions the gripper so that the gripper is not in contact with the object, then the flow through the vacuum cup 34 will be maximized. While the vacuum flow at the cup 34 will be high, the vacuum pressure at the cup 34 will be negligible as shown at 74 in FIG. 8A. This exception state can be detected in flow and/or pressure data from the pressure and flow meter 42.

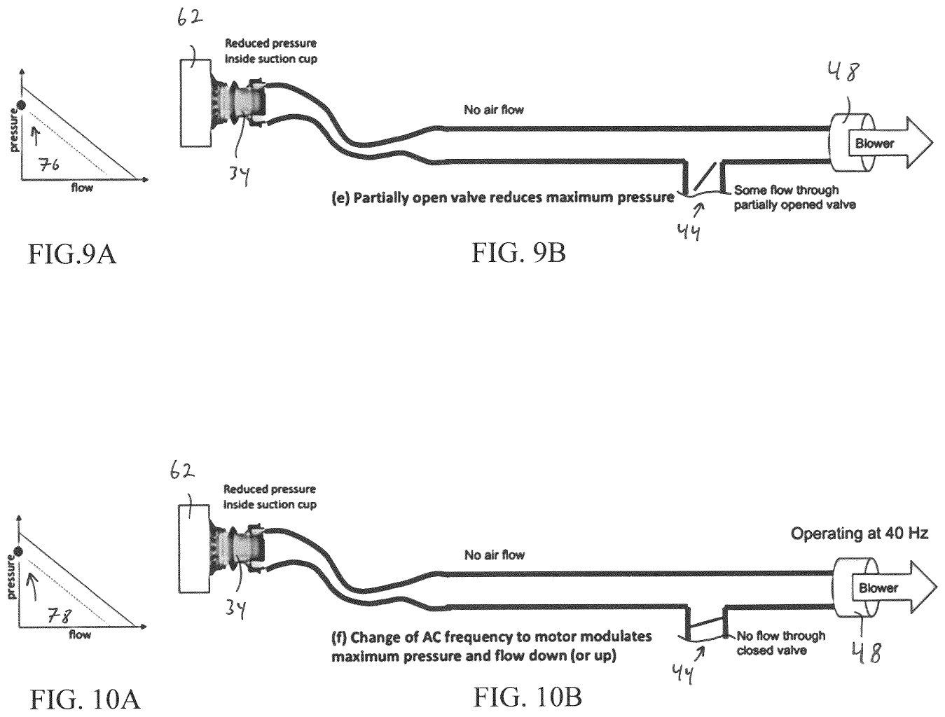

With reference to FIG. 9B, if the robotic system determines a need to grip an object with less vacuum pressure, e.g., to avoid damaging an object, then by setting the butterfly angle of the valve 44 to a specific angle in-between fully closed and fully open, the system may provide a different pressure-flow curve at the cup 34, with, in particular, a lower maximum pressure as shown at 74 in FIG. 9A.

With reference to FIG. 10B, if the robotic system determines a need to grip an object 62 with less vacuum pressure but with potentially further fine control over the vacuum pressure, e.g., again avoid damaging an item and optionally being responsive to sensed pressure or flow, the system may provide such a reduced pressure at the cup 34 by changing the frequency at which the AC motor operates for the blower 48. This will result in a different pressure-flow curve at the cup as shown at 78 as shown in FIG. 10A, with, in particular, a lower maximum pressure if the frequency is set lower than nominal (e.g., 40 Hz instead of 60 Hz). The lower line shown in each FIGS. 9A and 10A at 76 and 78 represent a modified pressure-flow performance curve as compared to an upper line (showing maximum pressure and flow) due to modulation of maximum pressure and flow either by valve position control or AC frequency control. Increased pressure could be attained by setting the frequency to higher than 60 Hz, depending on the blower. Note that some vacuum generating systems may have built-in frequency control and not require a separate variable flow device (VFD).

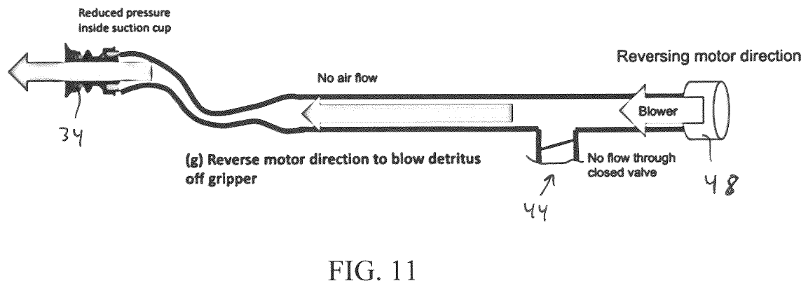

With reference to FIG. 11, if the robotic system determines a need to blow from the gripper, for instance to blow detritus away from the suction cup 34, then the motor controller can reverse the direction of the motor and generate compressed air to blow from the blower 48 through the suction cup 34 (assuming that the selected blower is compatible with reversing flow direction).

The arrangements shown in FIGS. 9B and 10B show two ways to accomplish a similar result of providing maximum pressure control. Maximum pressure control can be useful because damage can occur to an object when its exposed surface within the suction cup is exposed to too much vacuum pressure. Plastic wrap can blister or example, or other kinds of packaging can get warped or crushed. These arrangements may be available on one system. Alternatively, the blower may have properties that preclude frequency control, or the valve may not have precise position control, or maximum pressure control may not be needed for a robot's application and neither are available. If a VFD is not used or available, the system may implement the operating mode shown in FIG. 11, reversing the blower, using reversing contactors.

In accordance with further aspects, pneumatic control systems may employ more than one valve for increased pressure control. If a first valve has only two states, open and closed, then a second valve could be used to vent the system. This would not have the same high flow requirements, but might be a low cost solenoid valve to give an additional state of reduced pressure, or a servo valve that would be continuously variable. Another option is to employ a greater number of small flow valves that allow ambient air to enter, and then vary the number of valves that are opened in order to control maximum pressure.

The combined tee and valve design provides two key benefits. First, it allows for an unimpeded path from the blower to the suction cup, which as discussed above can facilitate gripping porous items. The maximum air flow at the suction cup is close to the maximum air flow of the blower. Second, the blower is generally always generating vacuum (exceptions are discussed below), so it prevents the blower from being deadheaded when the vacuum is not in use for gripping. The condition of deadheaded means the conduit to the blower inlet is sealed. Consider the alternative, where there was no tee but instead an in-line valve that was closed, then the space from the closed valve to the blower would be at maximum vacuum and have no flow. Air is therefore needed to pass through the blower to keep it from overheating, and so whether objects were being gripped or not, the blower would be deadheaded nearly 100% of the time. So instead, the open valve lets in ambient air, which cools the blower and prevents it from overheating. Furthermore, a regenerative blower, for instance, may exhibit significantly higher current draw (˜25%) when deadheaded.

Two important design variables are the diameter of the inlet to the valve, as well as the actuation time. The diameter of the valve needs to be large enough to have significantly lower pressure drop than the hose, so that when open, air takes the route through the valve and not the hose. In regards to actuation time, it is desired to be as low as possible, and so the mass of the disc is as low as can be while maintaining strength so as to minimize the torque required to actuate it. Other valve choices are possible, but a butterfly valve typically has low pressure drop and high speed actuation. A butterfly valve design supports valve actuation from on to off and off to on in the order of 100 milliseconds. The system application needs to wait at least this amount of time to detect whether a pick is successful based on this timing. There is a direct connection therefore to system throughput.

Another variable in the design is whether to include an additional relief valve. An additional valve may be used to reduce the possibility of deadheading the vacuum generator. Alternatively, the valve may be controlled to be partially open instead of closing fully. Another design might put the valve in-line, or in the path of air from suction cup to blower, i.e., not use a tee. In such cases it might be that the blower can tolerate deadheading, and that the pressure drop due to the valve is acceptable.

In the operating mode shown in FIG. 5B, it was explained that the position of the butterfly valve plate could be set to an angle other than fully closed or fully open in order to control maximum pressure at the cup when gripping. Trajectory control of the plate, i.e., setting position of the plate vs. time, can also be used to implement other behaviors. A first example is in placement. If the system is gripping an item, and the valve opens as quickly as possible, then the evacuated region from the suction cup to the hose will fill up with a volume of air entering through the valve. The momentum of the incoming air will tend to blow the object off of the gripper. In some cases this behavior may be undesirable where precise placement is desired (in some instances it might actually be desirable so that there is a moderate ejection of the object from the gripper, e.g., placing into a shuttle). An alternative to rapid valve opening is to implement a trajectory that introduces a brief but moderate leak to reduce the initial mass of air, and then as the valve gradually opens more, to reduce the velocity of the additional volume of air because of the slightly increased pressure created by the initial volume of air. Thus, the average momentum of the air mass is reduced and ejection is minimized or eliminated.

The second example is picking. During a picking trajectory the system can preemptively close the valve by, for example, 60% during robot arm motion so that when the robot arrives at the picking location, it can more quickly close all the way, with the effect of reducing latency waiting for the valve to close, and increasing system throughput. In general the trajectory control of the valve position can be coupled to or synchronized with trajectory control of the robot, so as to control timing of each to implement various behaviors, with the aim of increasing throughput or controlling the effects of the pneumatic system.

Pressure and flow sensors can be used to detect a variety of states. The pressure-flow illustrates that pressure and flow are subject to a constrained relationship; pressure provides information about flow and vice versa. Nevertheless, both sensing modalities can be used for redundancy, and to exploit advantages of each. Generally flow data will be noisier than pressure data, but pressure data will be slower to react to events.

Drop detection may be achieved by applying a threshold the pressure/flow data. This may also be done by monitoring for a drop in negative pressure or an increase in flow versus the initial value measured at the time the seal was determined to be a valid grasp. Signal processing and machine learning techniques may also be used to classify the pressure/flow signal as an imminent drop situation.

Successful pick detection may be determined by monitoring the pressure sensor's signal and detecting that some minimum negative pressure value is present. Depending on the cost of a drop of a poorly gripped object—one might want to monitor the grip-quality signal for some period of time before beginning to move the item. If maximizing throughput, then one might opt to start transferring the item once it is observed that a good grasp is imminent by monitoring the slope of the negative pressure instead of waiting for a specific threshold to be hit. This might lead to more early drops but would save time when detecting grips and early drops might result in the object returning to where it was picked from in the first place.

If item attributes are known, then a partial seal may be detected when maximum negative pressure is not achieved on a non-porous item and the system can decide whether to regrasp it or transfer it slowly. The system may therefore choose use of pressure or flow depending on the SKU's pick surface's attributes. For example, for a porous object, the system may use flow data instead of pressure for a clearer signal. For a porous object that is also small, where a small cup is used, the system may need to use flow data instead of pressure because the small cup will not provide a consistent minimum negative pressure to threshold on given the flow-pressure curve. For a porous object that is large, where a large cup is used, the system may also use flow data instead of pressure to detect successful grip. If the large cup allows for enough flow however, then the negative pressure will be higher up on the flow-pressure curve, so the system might be able to achieve a consistent detectable value.

When the robot is controlled by a real-time stream of high frequency waypoints from the high level software, its travel speed with the object in tow can be modulated by the grip quality to reduce drops. The system may choose to either (1) use a smaller cup with a high pressure seal or (2) use larger cup with a partial seal (relying on the high flow)—to achieve adequate grip-force to transfer an item. In accordance with further aspects, the system may detect a contour of the pick surface beneath the grasp location, and use this information to inform the quality of seal to be expected at the grip, which can inform the robot to switch to a larger cup before attempting the pick. In particular, the system may inform cup selection based on contours of the segment item's pick surface. Knowing this, the system may elect to execute a high flow pick or a high pressure pick depending on how the item is presenting in the tote. The system may also learn whether a partial seal is more likely on a given SKU using historical data and then opt for a larger cup despite the fact that the item is very light or smaller.

The system is able to check if an unexpected obstruction, such as trash, exists in any part of the pneumatic path (e.g. gripper, hose) between picking operations. This is done by closing the valve to enable suction, when the suction cup should be at a point in space in which no contact with a blocking surface is expected, such as mid-air in an open part of the workspace. The system may then check if negative pressure exists similarly to how the grip quality on an item is measured. If the conduit were unblocked, the pressure sensor should report atmospheric pressure. The same operation can be done using the flow sensor as well (e.g., trash in the hose is likely if the flow measurement is below some nominal flow value). To check for trash with a minimal throughput hit, the system may perform the check during the initial segment of a pick trajectory and interrupt it if an item is present. This requires knowing that the check will be performed while the gripper is far enough away from the object that is targeted to be grasped.

The system may also monitor residual flow when not picking to compare blower performance to historic performance, or to detect blockage, or other issues in the pneumatic system. In accordance with further aspects, the placement of flow and pressure sensors may affect timing. Sensors may be placed to minimize latency of detecting various kinds of events.

Pressure and flow sensors nearer the gripper for example, may provide an earlier indicator of the onset of a loss of seal compared with sensors near the valve. Additionally, pressure and flow sensors nearer the valve provide an earlier indicator of the onset of a seal compared with gripper-mounted sensors.

For the purposes of diagnosing or inferring the location of problems, two pressure/flow sensors may help resolve issues at different segments of the conduit (e.g., to determine whether the hose is more probably a problem or whether the gripper is more probably a problem when an issue is identified). In accordance with further aspects, the system may employ a contact sensor, such as a magnetic field sensor, in the gripper to detect when there is contact between the gripper and the object by detecting if the position of the compliant tube that the suction cup is mounted to has changed with respect to the rest of the gripper body. This also prevents lip curl due to the high flow that could prevent the generation of a good seal. Further, the suction cups are interchangeable with a tool changer. In particular, the system supports changing the tooltip via a quick tool changer, and the gripper should be designed to withstand the ejection force of the inrush of air against the tooltip's bellows, as well as the decompression of the gripper when the compliance is coupled to the vacuum source. The sensor detects the presence of a suction cup at the end of the tooltip of the gripper, where the suction cup is mounted.

The design of the valving system supports a 100% duty cycle for the blower: the blower can be always on, and the valves enable on-off vacuum switching at the suction cup. But the design may also support idling the blower to improve energy efficiency. Most VFDs have a coast mode that turns off the power to the blower motor but does not actively ramp velocity down to zero. The impeller of a regenerative blower for example, may have considerable inertia and will continue spinning, storing some of the energy as kinetic energy. In this way a system can set the blower to coast in-between picks. There are various ways to implement deciding when to go to coast mode depending on what timing horizon is provided for when the next pick task will be ordered. When no significant timing horizon is provided, a simple timeout can be employed, that is, after the system is idle for a specified period of time the system commands the blower to coast. This is balanced against how early the next pick task is typically known in advance (if it takes 10 seconds for the blower to ramp, but there is only 3 seconds advance notice for a pick, and if pick to pick is typically 15 seconds, then timeout might be 60 seconds, for example, to avoid adding a wait to ramp up before every pick). If longer timing horizons are available, so that pick orders are known 15 seconds in advance, and it takes 10 seconds to ramp, then the system can appropriately plan when to ramp, starting 10 seconds before planned pick.

The pneumatic control system may therefore identify a first period of time between discharge of a first object being grasped and an initial grasp of a second object to be grasped subsequent to the first object; and identify a second period of time that is less than the first period of time during which power to the rotating element is decreased and subsequently increased such that the rotating element returns to the first rotational speed prior to grasping the second object. In accordance with certain aspects, the system may provide, using at least in part a rotating element, a high flow vacuum at the end-effector when the rotating element is rotating at a first rotational speed, identify a first period of time between discharge of a first object being grasped and an initial grasp of a second object to be grasped subsequent to the first object, decrease power to the rotating element for a second period of time that is less than the first period of time, and increase rotational speed of the rotating element prior to grasping the second object. The momentum of the rotating element of the blower may be used to conserve potential energy while reducing energy consumption when not grasping.

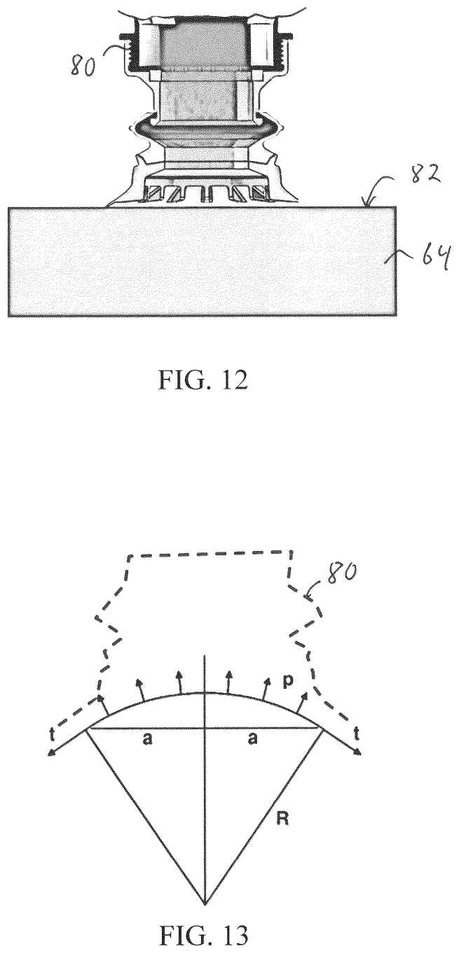

The combination of the system being able to change vacuum cup sizes and modulate the vacuum pressure and flow at the vacuum cup provides substantial control over the vacuum grasping system. For example, FIG. 12 shows a diagrammatic sectional view of a vacuum cup 80 used in a gripping system engaging a surface 82 of an object 84. FIG. 13 shows an illustrative force diagram of the forces in the interior of the vacuum cup 80 as the vacuum force is acting on the object 84. As shown in FIG. 13, the radius of the vacuum cup 80 is shown at a and the negative pressure exerted at each patch of the object is shown at p. The bulge due to the pressure is an exaggeration of the deflection that would be seen on the packaging. For large enough pressures this deflection may exceed the plastic limits of the packaging, whether it is cardboard, shrink wrap, rigid plastic, or some other material. Shrink wrap in particular can easily deform if the stress exceeds the plastic limits of the material.

With reference to FIG. 13, the tension per unit length along the perimeter of the area exposed to vacuum is shown at t, and the force in the z-direction due to pressure on the film is approximately πα² p. The opposing force in the z-direction is −2παt. This implies that t=a p/2, which has units of newtons per meter. The stress in the plastic film is σ=αp/2τ where τ is the thickness of the film. A limit on stress a then implies an upper limit on p for a cup of inner radius α. In some circumstances therefore, the system may evaluate the cup and pressure combination in order to obey the above constraints on stress in the plastic film. Other limits may apply in order to avoid damage to other kinds of packaging.

Generally the gripper will have some compliance so that when it begins to grip an object, there is a low chance of applying too much force to the object via collision. Such a gripper may be either a vacuum coupled gripper or vacuum decoupled gripper. FIG. 14 diagrammatically shows an end-effector mounting bracket 90 with an internal spring 92 that is coupled to the vacuum source and acts on a vacuum cup attachment portion 94. FIG. 15 diagrammatically shows the end-effector mounting bracket 90 with an internal spring 96 that is decoupled from the vacuum source and independently acts on a vacuum cup attachment portion 98. The fundamental design of the compliant mechanism will therefore be designed in one of two ways; the gripper compliance and vacuum source can be coupled or decoupled. If it is coupled (FIG. 8), then when air is evacuated from the conduit, the negative pressure will cause the compliant end to retract into the gripper. The gripper will remain in the retracted state as long as system vacuum is maintained. Once the vacuum is removed, the gripper will return to the extended position. The return to extension may add kinetic energy to the formerly gripped item. This may or may not be desirable.

In a decoupled gripper (FIG. 15), the vacuum system is separate from the compliant mechanism. As such, the gripper will always be in the extended position, unless it is pressed against an item. The vacuum does not influence the state of compliance (except as it might be exerted through changes in tension in the hose with vacuum state as transmitted through the elbow; that is, the vacuum state can change the stiffness of the hose, which can transmit forces to the elbow and from there to the gripper).

Those skilled in the art will appreciate that numerous modifications and variations may be made to the above disclosed embodiments without departing from the spirit and scope of the present invention.

What is claimed is:

1. A system for providing high flow vacuum control to an end-effector of a programmable motion device, said system comprising:
a vacuum source for providing a high flow vacuum;
a conduit path leading from the end-effector to the high flow vacuum source;
a sensor system for sensing any of a pressure or a flow at any of the end-effector, the conduit path, and the vacuum source, and providing sensor information; and
a pneumatic control module including a vacuum pressure adjustment system for adjusting the high flow vacuum within the conduit path responsive to the sensor information.

2. The system as claimed in claim 1, wherein the vacuum source provides a vacuum pressure of no more than about 65,000 Pascals below atmospheric.

3. The system as claimed in claim 1, wherein a maximum air flow rate from the vacuum source is at least about 100 cubic feet per minute.

4. The system as claimed in claim 1, wherein the high flow vacuum source is provided with a blower that is controlled to coast between grasping objects.

5. The system as claimed in claim 4, wherein the high flow vacuum source is provided with a blower that is controlled to re-start when coasting prior to grasping a new object.

6. The system as claimed in claim 1, wherein the high flow vacuum source includes side-channel blower.

7. The system as claimed in claim 1, wherein the pneumatic control module includes an analog adjustable valve in fluid communication with the conduit path.

8. The system as claimed in claim 7, wherein the analog adjustable valve is coupled to a source of air at atmospheric pressure.

9. The system as claimed in claim 7, wherein the analog adjustable valve is a variable angle butterfly valve.

10. The system as claimed in claim 1, wherein the pneumatic control module includes a variable frequency power source coupled to the vacuum source.

11. The system as claimed in claim 10, wherein the variable frequency power source includes a variable frequency drive and a multi-phase power source.

12. The system as claimed in claim 1, wherein the pneumatic control module includes both an analog adjustable valve in fluid communication with the vacuum path and a variable frequency power source coupled to the vacuum source.

13. The system as claimed in claim 1, wherein the end-effector includes a first vacuum cup and wherein the system further includes a plurality of additional vacuum cups that may be exchanged with the first vacuum cup by the system responsive to the sensor information.

14. The system as claimed in claim 13, wherein the sensor information is associated with the first vacuum cup to determine whether any of the plurality of additional vacuum cups should be exchanged with the first vacuum cup by the system due to stress limitations on the packaging of an object if grasped by the first vacuum cup.

15. The system as claimed in claim 1, wherein the system further includes a sensor system for sensing any of a pressure or a flow at any of the end-effector, the conduit path, and the vacuum source, and providing sensor information.

16. The system as claimed in claim 15, wherein the end-effector includes a first vacuum cup and wherein the system further includes a plurality of additional vacuum cups that may be exchanged with the first vacuum cup by the system responsive to the object grasping information.

17. The system as claimed in claim 16, wherein the object grasping information is associated with the first vacuum cup to determine whether any of the plurality of additional vacuum cups should be exchanged with the first vacuum cup by the system due to stress limitations on the packaging of an object if grasped by the first vacuum cup.

18. A system for providing high flow vacuum control to an end-effector of a programmable motion device, said system comprising:
a high flow vacuum source including a rotating element that provides a high flow vacuum at the end-effector when the rotating element is rotating at a first rotational speed; and
a pneumatic control system for identifying:
a first period of time between discharge of a first object being grasped and an initial grasp of a second object to be grasped subsequent to the first object; and
a second period of time that is less than the first period of time during which power to the rotating element is decreased and subsequently increased such that the rotating element returns to the first rotational speed prior to grasping the second object.

19. The system as claimed in claim 18, wherein the vacuum source provides a vacuum pressure of no more than about 65,000 Pascals below atmospheric.

20. The system as claimed in claim 18, wherein a maximum air flow rate from the vacuum source is at least about 100 cubic feet per minute.

21. The system as claimed in claim 18, wherein the high flow vacuum source includes side-channel blower.

22. The system as claimed in claim 18, wherein the pneumatic control module includes an analog adjustable valve in fluid communication with the conduit path.

23. The system as claimed in claim 22, wherein the analog adjustable valve is coupled to a source of air at atmospheric pressure.

24. The system as claimed in claim 22, wherein the analog adjustable valve is a variable angle butterfly valve.

25. The system as claimed in claim 18, wherein the pneumatic control module includes a variable frequency power source coupled to the vacuum source.

26. The system as claimed in claim 25, wherein the variable frequency power source includes a variable frequency drive and a multi-phase power source.

27. The system as claimed in claim 18, wherein the pneumatic control module includes both an analog adjustable valve in fluid communication with the vacuum path and a variable frequency power source coupled to the vacuum source.

28. The system as claimed in claim 18, wherein the system further includes a sensor system for sensing any of a pressure or a flow at any of the end-effector, the conduit path, and the vacuum source, and providing sensor information.

29. The system as claimed in claim 28, wherein the end-effector includes a first vacuum cup and wherein the system further includes a plurality of additional vacuum cups that may be exchanged with the first vacuum cup by the system responsive to the sensor information.

30. The system as claimed in claim 29, wherein the sensor information is associated with the first vacuum cup to determine whether any of the plurality of additional vacuum cups should be exchanged with the first vacuum cup by the system due to stress limitations on the packaging of an object if grasped by the first vacuum cup.

31. A method of providing high flow vacuum control to an end-effector of a programmable motion device, said method comprising:
providing, using at least in part a rotating element, a high flow vacuum at the end-effector when the rotating element is rotating at a first rotational speed;
identifying a first period of time between discharge of a first object being grasped and an initial grasp of a second object to be grasped subsequent to the first object;
decreasing power to the rotating element for a second period of time that is less than the first period of time; and
increasing rotational speed of the rotating element prior to grasping the second object.

32. The method as claimed in claim 31, wherein providing the high flow vacuum source includes using a side channel blower to provide a vacuum at the end-effector with a pressure of no more than about 65,000 Pascals below atmospheric and a flow rate from the vacuum source of at least about 100 cubic feet per minute.

33. The method as claimed in claim 31, wherein the method further includes adjusting an analog adjustable valve in fluid communication with a conduit path between the end-effector and the vacuum source.

34. The method as claimed in claim 33, wherein the analog adjustable valve is coupled to a source of air at atmospheric pressure.

35. The method as claimed in claim 31, wherein decreasing the power to the rotating element includes adjusting a variable frequency power source coupled to the vacuum source.

36. The method as claimed in claim 31, wherein decreasing the power to the rotating element includes adjusting a variable frequency drive and a multi-phase power source.
